(19) United States
(12) Patent Application Publication
(10) Pub. No.: US 2025/0008929 A1
(43) Pub. Date: Jan. 9, 2025

(54) Robot for Direct Sample Capture in a Live Animal Study

(71) Applicant: Milan Amul Shah, Chesterbrook, PA (US)

(72) Inventor: Milan Amul Shah, Chesterbrook, PA (US)

(21) Appl. No.: 18/349,154

(22) Filed: Jul. 9, 2023

(51) Int. Cl. A01K 29/00; G01N 1/22; G05D 1/00; G05D 1/02

(52) U.S. Cl. CPC A01K 29/005; G01N 1/22

(57) ABSTRACT

The method involves moving an apparatus with a sampling unit in an animal enclosure to collect air samples while monitoring environmental parameters and using navigation techniques to avoid obstacles. An apparatus is provided that interacts with animals, collects direct samples, and can be in the form of a robot. The robotic system successfully collects aerosol samples, interacts with animals without disruption, and detects viable biological particles on its surfaces. It moves slowly, preventing harm to animals and maintaining study integrity. The robot is remotely controlled, adaptable to different environments, and has a compact size, programmable drivetrain, and extended battery life. Iterative design improvements based on scientist feedback refined the robot's performance, including maneuverability, size, speed, and battery life, ensuring valuable data collection for scientific research.

### BACKGROUND

Live animal studies are an essential tool for scientific research in fields such as medicine, biology, and environmental science. These studies often involve monitoring and analyzing the air quality in the animal's environment and any expelled aerosols during laboratory experiments, to study the impact of various factors on the animal's health and behavior. In animal research, studying the composition and quality of the air within the animal's living environment is crucial for understanding their physiological responses and overall well-being.

Existing methods for air sampling often involve intrusive or disruptive procedures that may cause stress to the animals, thereby affecting the reliability of the data collected. Traditional methods of air and environmental sampling involve human operators, which can introduce unwanted variables such as movement, vibration, or stress to the animal observations. Furthermore, these methods can be time-consuming and may not provide consistent results. Other current methods for capturing this sort of data include sensors (103) attached to the outer perimeter of study enclosures (101, 102) and not direct capture (illustration shown in FIG. 1A). There is no apparatus that allows for consistent direct air sampling.

### SUMMARY

A method for sampling air in a live animal study. The method includes moving an apparatus having a sampling unit within an enclosure containing animals while collecting air samples using the sampling unit, monitoring environmental parameters using the sensors, and using a combination of navigation techniques including navigation algorithms and obstacle detection sensors to avoid collisions with obstacles or the animals. In another aspect, the invention includes an apparatus that can be placed in an enclosure with animals, interact with the animals, and can collect direct samples from the animals.

In one aspect, this invention provides a robot capable of interacting with animal study subjects and collecting their expelled air, secretions, and excretions. The robot can incorporate biosensors for collecting aerosols to detect viruses or any other laboratory endpoint, and measuring environmental properties like CO2 levels, temperature, and humidity during exposure events. The robot autonomously navigates within the animal environment. This novel robotic system overcomes the challenges of capturing direct samples from animal subjects during laboratory experiments. Illustrated with 105 in 106 and 107 with 108 in 109 in FIG. 1B and FIG. 1C.

This invention is a novel apparatus designed to address the aforementioned need. The robot comprises a stable base with maneuvering capabilities, can be outfitted with biosensors such as an air sampling module, and includes an intelligent control system. The robot is specifically programmed to move at a controlled pace and maintain stability while collecting samples in animal environments, ensuring accuracy and minimizing disruption to the animals under study.

The robot for direct subject sampling in a live animal study is designed to address the challenges posed by traditional methods of direct sampling. The robot incorporates various features to ensure successful expelled aerosol, secretion, and excretion collection, as well as providing a safe and non-threatening environment for the animals. Additionally, the robot can be outfitted with biosensors to detect viruses, bacteria, other particles of scientific interest, and measure relevant environmental parameters during exposure events.

The collected data contributes to better understanding of animal study-related research, for example and not limited to viral airborne transmission mechanisms. These deeper scientific understanding can aid in the development of preventive measures.

To ensure scientifically relevant collection of samples, the robot moves slowly and steadily, minimizing any unnecessary movement or vibration. The robot can be controlled remotely by a human operator, allowing for precise navigation through different environments and terrains. The robot can also be programmed to run autonomously in a pre-determined pattern. The robot can collect samples consistently, providing reliable data for scientific analysis.

The robot design has undergone extensive testing and evaluation, demonstrating its effectiveness in capturing direct study subject samples and facilitating accurate detection of study endpoints, for example and not limited to airborne viruses. One remarkable outcome of these experiments is the positive response from the study subjects. The robot's non-threatening design and gentle interaction have resulted in the subjects being comfortable, cooperative and curious around the robot, ensuring reliable data collection. Furthermore, the post-experimentation analysis revealed the presence of study subject expelled aerosols, including but not limited to infectious viruses on the robot's surface, indicating its efficiency in capturing viable biological particles.

Throughout the development process, the inventor faced and overcame several challenges. Initial iterations of the robot exhibited jerky movement, noise, and scraping against the ground. These issues were resolved through rigorous problem-solving and design modifications. The robot's wheels were optimized, and adjustments were made to its dimensions to enable smooth and quiet movement, ensuring minimal disruption to the study subject's natural behavior. Efforts are also underway to extend the robot's battery life to accommodate longer exposure durations, maximizing the utility of the device.

### BRIEF DESCRIPTION OF THE DRAWINGS

FIG. 1A is a live animal experimental setup: Traditional Setup.

FIG. 1B is live animal experimental setup with direct sample capture experiment with the invention a “A Robot for Direct Sample Capture in a Live Animal Study”.

FIG. 1C is live animal experimental setup with direct sample capture with the invention in a slightly different setup.

FIG. 2A are isometric views top-side-front-of example robot sizes and dimensions. The robot consists of a mobile platform.

FIG. 2B are isometric views top-side-front-of example robot sizes and dimensions. The robot consists of a mobile platform.

FIG. 2C are isometric views top-side-front-of example robot sizes and dimensions. The robot consists of a mobile platform.

FIG. 2D are isometric views top-side-front-of example robot sizes and dimensions. The robot consists of a mobile platform.

FIG. 3 is an example interior view of the chassis and drivetrain with Intelligent Control System, wheels, high-tension chain, motors, battery, robot body, and structural supports.

FIG. 4A is an example wheel, 4″ omni wheel.

FIG. 4B is an example wheel, 1.25″ traction wheel.

FIG. 4C is an example wheel, 1.25″ omni wheel.

FIG. 4D is an example wheel 4″ mecanum wheel.

FIG. 4E is an example wheel, 2″ mecanum wheel.

FIG. 5A are example gears such as (from left to right) 6 tooth sprocket, 12 tooth sprocket, 18 tooth sprocket.

FIG. 5B is an example high strength chain.

FIG. 5C are example sprockets linked with chain.

FIG. 6A is an example propulsion system, VEX V5 11-watt motors, used to power the wheels and gears in the invention.

FIG. 6B is an example propulsion system, VEX V5 5.5-watt motors, used to power the wheels and gears in the invention.

FIG. 7 is an example of a Robot Intelligent Control System such as the VEX V5 Robot Brain.

FIG. 8A is an example of a power supply battery and battery life extension VEX V5 Robot Battery Li-Ion 1100 mAh.

FIG. 8B is an example of a power supply battery and battery life extension Vexilar MAX Lithium Battery 12 Volt/12 AH V-200L.

FIG. 8C is an example of a power supply battery and battery life extension VEX 7.2V Robot Battery NiMH 3000 mAh.

FIG. 8D is an example of a power supply battery and battery life extension Robot Battery NiMH 2000 mAh—VEX Robotics.

FIG. 9 is an example of a remote radio, such as the VEX V5 Robot Radio, which allows your V5 Robot Brain to communicate with other devices.

FIG. 10A is an example of an obstacle sensor that, VEX Bumper Switch, may be added onto the robot as safety measures when the robot is being operated in autonomous mode.

FIG. 10B is an example of an obstacle sensor that, VEX Limit Switch, may be added onto the robot as safety measures when the robot is being operated in autonomous mode.

FIG. 10C is an example of an obstacle sensor that, VEX Vision Sensor, may be added onto the robot as safety measures when the robot is being operated in autonomous mode.

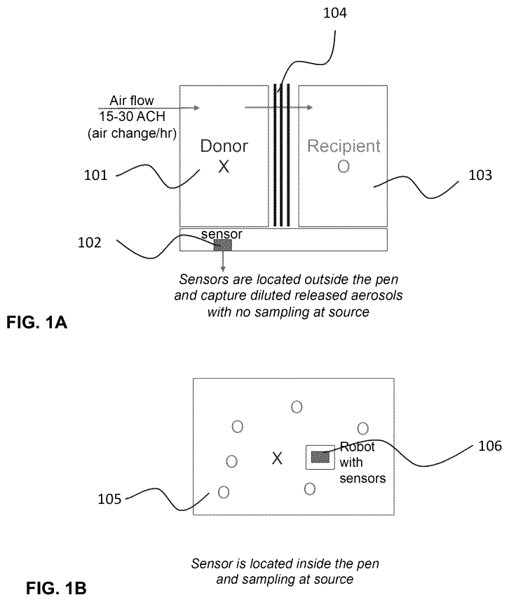

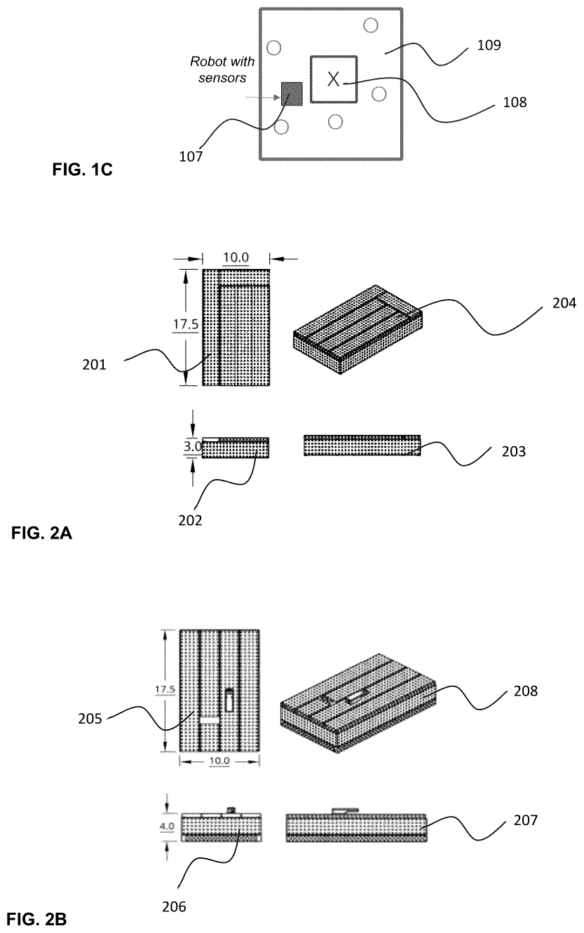

### DETAILED DESCRIPTION

For simplicity and illustrative purposes, the present invention is described by referring mainly to an embodiment thereof. In the following description, numerous specific details are set forth in order to provide a thorough understanding of the present invention. It will be apparent however, to one of ordinary skill in the art, that the present invention may be practiced without limitation to these specific details. In other instances, well known methods and structures have not been described in detail so as not to unnecessarily obscure the present invention.

The robot's design facilitates the gentle and non-threatening interaction with study subjects, ensuring minimal disruption to their behavior during laboratory experiments. By employing various iterations and incorporating feedback from qualified scientists, the robot's design has been continuously improved, addressing factors such as maneuverability, size, speed, and battery life.

The robot's primary function is to safely interact with study subjects and enable the collection of directly expelled aerosols or other secretions/excretions from the subjects. The robot can be equipped with biosensors, and can effectively capture direct samples during the interaction, enabling the detection and analysis of biologics of scientific interest. Additionally, the robot can include sensors to measure environmental conditions, such as CO2 levels, temperature, and humidity, providing valuable data on the surrounding atmosphere during the laboratory study. These comprehensive measurements contribute to furthering scientific experimental data collection.

It has a compact form factor, allowing it to fit within a small enclosure while still providing enough space for the necessary components. The robot's drivetrain has been specifically programmed to enable slow and quiet movement, minimizing any potential disturbance to the study subjects. The custom drivetrain utilizes a joystick as a coordinate plane, enabling precise control over speed and direction. Iterative design improvements have been made based on transmission data collected from animal studies, ensuring optimal performance in terms of maneuverability, size, speed, and battery life.

The biosensors can be strategically positioned upon the robot to capture expelled aerosols and measure environmental parameters. These biosensors can employ advanced detection techniques, for example with the capability to identify viruses present in the collected samples contributing to a deeper understanding of viral airborne transmission. Additionally, the robot's design and nonporous body allows for post-experimentation swabbing, which has revealed the presence of infectious biologics on the robot's surface—an observation that is rarely seen in other study setups using inanimate surfaces.

The invention emphasizes iterative design improvements based on feedback from qualified scientists. After each experiment, scientists provide valuable insights on the robot's performance, including maneuverability, size, speed, and battery life. These inputs drive continuous enhancements and refinements to the robot's design, resulting in improved usability and data quality capture. Collaborative efforts between the inventor and laboratory scientists ensure that the robot's design aligns with the specific requirements of the scientific study objectives. The feedback-driven iterative process allows for customization and optimization based on the needs of the experiments.

Through rigorous testing, the robot has demonstrated its efficacy and reliability. Notably, the study subjects have responded positively to the robot, exhibiting no signs of fear. This is a crucial factor in ensuring accurate data collection, as any stress or agitation among the subjects could lead to altered results. Furthermore, post-experimentation analysis has shown that biological particles can be recovered from swabbing the robot, underscoring the robot's effectiveness in capturing and retaining viable biological particles.

Moving forward, the inventor plans to collaborate closely with laboratory scientists to analyze the data collected by the robot's sensors. This analysis will involve statistical and machine learning techniques to identify patterns and correlations between the robot's design and the captured data. As animal studies progress and potential expansions into human studies are considered, continuous design iterations will be pursued to further enhance the efficiency and effectiveness of the robot.

This invention represents a significant contribution to the field of laboratory studies, particularly in virology and epidemiology. By providing a reliable and non-intrusive means of capturing direct samples from live study subjects, the invention offers valuable insights into biological processes, for example and not limited to viral transmission dynamics. With future outbreaks and pandemics anticipated, this innovation has the potential to aid in the development of preventive measures, mitigation strategies, and the improvement of experimental protocols in laboratory settings.

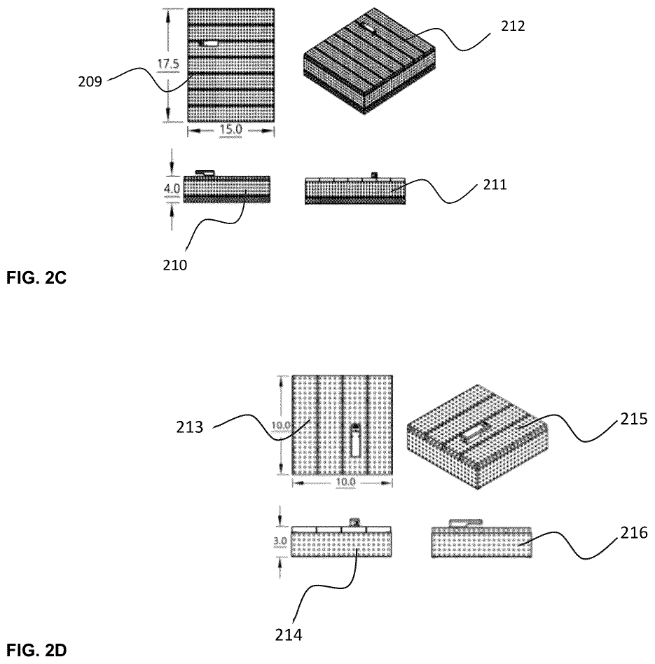

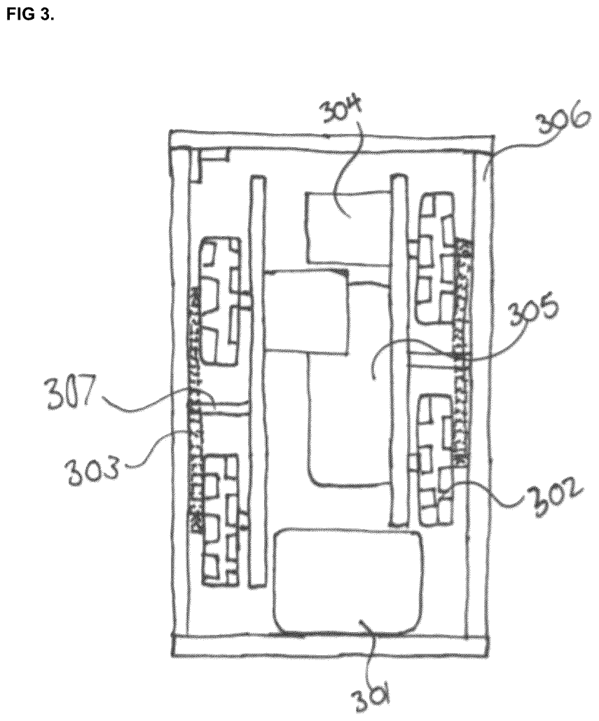

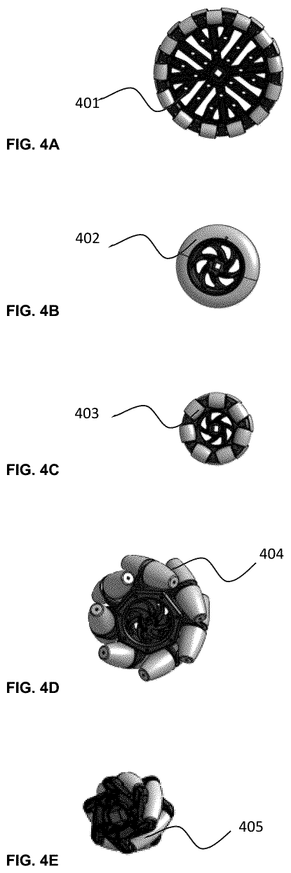

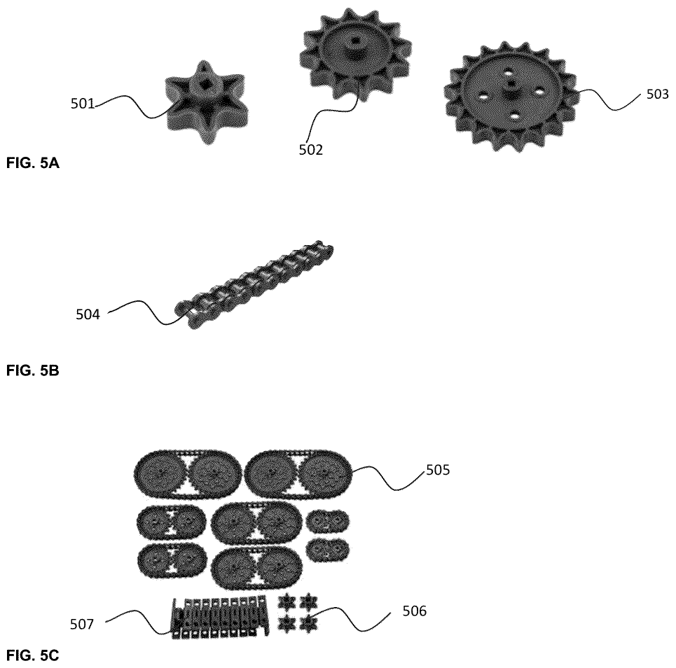

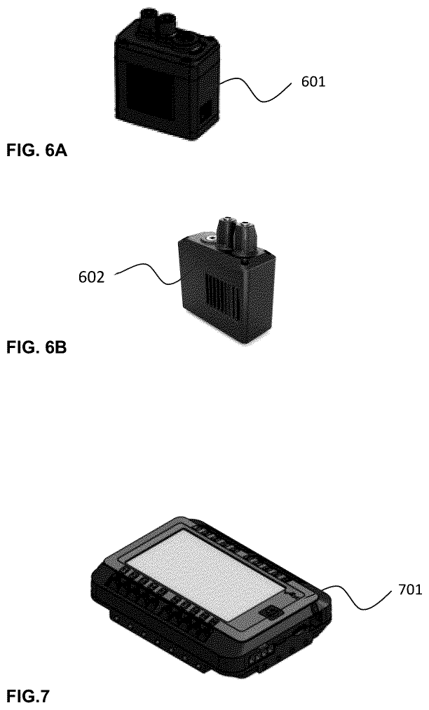

The following detailed description outlines the preferred embodiment of the invention, supported by the data collected during animal experiments and iterative design improvements. The robot for direct sampling in a live animal study comprises of a body, a sampling device, a propulsion system, intelligent control system, power supply, remote radio signal. These features are illustrated in the accompanying figures.
1. Robotic Body: The robot consists of a stable and maneuverable platform, 306 shown for example in FIG. 3, equipped with wheels, examples 401, 402, 403, 404, 405 in FIG. 4, or tracks or chains used to connect gears pairs with wheels, examples 504, 505, 506, 507 in FIG. 5B and FIG. 5C, or any other suitable locomotion mechanism for mobility and navigation capabilities. The platform is designed for navigation and to move slowly and smoothly to prevent startling the animals. The body is designed to be compact and lightweight, with a low center of gravity to ensure stability.
   a. Size and Structure: The robot is designed to fit within a small box, allowing it to operate effectively in laboratory settings, examples 201, 202, 203, 204, 205, 206 in FIG. 2A, FIG. 2B, FIG. 2C, and FIG. 2D. The compact design facilitates easy movement and maneuverability. Undercarriage design illustrated in FIG. 3 301, 302, 303, 304, 305, 306, 307.
   b. Maneuverability: The robot incorporates a custom drivetrain that enables slow and controlled movement, ensuring minimal disturbance to the study subjects. The robot's movement is calibrated to avoid frightening the animals while maintaining precise positioning during sample collection.
   c. Noise Reduction: Modifications have been made to reduce noise levels during robot operation, preventing unnecessary stress on the animals. Noise dampening materials, for example 401, 403, 404, 405, and optimized motor control, for example 601 and 602, contribute to a quiet and non-disruptive robot operation.
   d. Decontamination: the robot body is composed of materials that can be decontaminated and cleaned between each experiment.
   e. Safety: no exposed wires and no sharp edges to ensure no animal is harmed.
2. Propulsion system: The propulsion system is designed to move the robot slowly and steadily, with minimal vibration or noise. The propulsion system is enabled by a casing, such as the VEX V5 Smart Motor, to bring together the motor, gears, encoder, modular gear cartridge, circuit board, thermal management, packaging, and mounting, for example FIG. 6A. 601 and FIG. 6B 602. Users can consistently control the motor's direction, speed, acceleration, position, and torque limit. Software limits the motor's max speed, which not only makes the performance across different motors more consistent but allows the motor to operate at max speed while under load.
3. Intelligent Control System: The robot is equipped with an intelligent control system that governs its movement, speed, and stability. The robot is controlled by a central processing unit (CPU) (20) that manages the overall operation, navigation, and data processing. The robot can be programmed to follow a predetermined path or can be controlled manually for more precise movement.

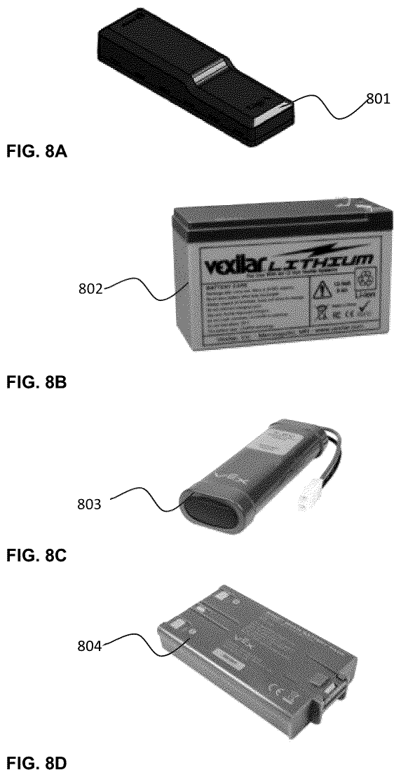

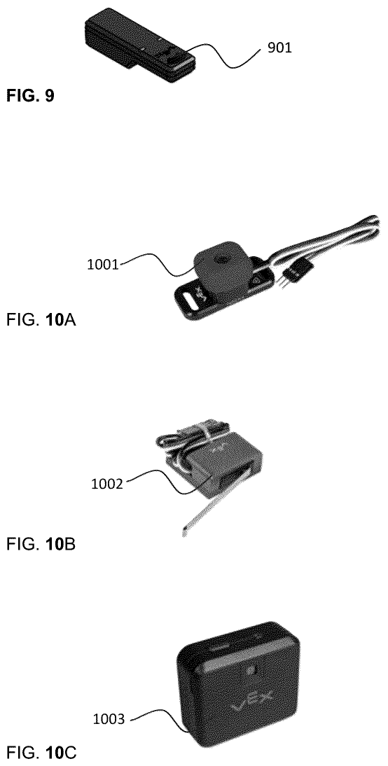

The robot can employ navigation algorithms, obstacle detection sensors, and safety protocols to avoid collisions with obstacles or animals. The intelligent control system is fully programmable in coding languages such as Blocks, Python, and C++, and has ports for the battery, motors, radio, and sensors. It allows for a wired and wireless connection to a controller, and it communicates with a remote control interface. An example intelligent control system is 701 in FIG. 7. 4. Power Supply: The robot is powered by a rechargeable battery or an external power source, providing sufficient energy for extended operation periods. a. The robot incorporates features and components that aim to extend the battery life, allowing for longer exposure durations and continuous data collection. Efficient power management systems, low-power components, and optimized algorithms contribute to prolonged operation times. b. External Battery Packs: To address the need for extended operation times, external power sources can be easily connected to the robot, ensuring uninterrupted data collection during prolonged experiments. An example includes VEX V5 Robot Battery, designed to work together with the V5 Robot Brain and Smart Motor(s) to power a consistent and reliable performance, even when the battery charge is low. Examples shown in 801, 802, 803, 804 in FIG. 8A, FIG. 8B, FIG. 8C, and FIG. 8D.
5. Remote Radio: The remote radio enables incorporation of wireless communication capabilities for remote monitoring and control of the robot. In operation, the robot can be placed in the animal's environment and controlled remotely by the human operator. An example device is the VEX V5 Robot Radio which allows the V5 Robot Brain to communicate with other devices. All wireless communication to the brain is done through the radio, including wireless control and wireless activation of VEX Coding Studio programs. The V5 Robot Radio, powered by VEXnet 3 and Bluetooth, can be used for driving, downloading, and debugging. Example is 901 in FIG. 9.
6. Obstacle Sensors: Obstacle detection sensors may be added onto the robot as safety protocols when the robot is being operated in autonomous mode or with a navigation algorithm. The sensor can include, but not be limited to a single digital switch with a spring-loaded bumper which can be pushed in to change the state of the switch and initiate the robot to either stop its forward movement or switch directions. This switch requires only a light touch to activate. A sensor could also include a visual input to the robot of its surroundings and enable the recognition of colors, patterns, or be used to follow an object. Examples of such sensors are VEX Bumper Switch, VEX Limit Switch, and VEX Vision Sensor. Examples shown in 1001, 1002, 1003 in FIG. 10A, FIG. 10B, FIG. 10C.
7. Sampling Apparatus: The robot can include a sampling apparatus designed to meet specific scientific requirements with multiple air intake ports strategically placed to capture air samples at different heights, depths, and positions. The apparatus may employ filters or other sampling mechanisms to collect direct animal samples, environmental samples, and cameras that can provide real-time data to the human operator. The sampling device is attached to the body and can collect direct samples from the animal's environment without causing any harm or disturbance.

### ADVANTAGES

The virus collection robot described in this invention offers several advantages and novelty over existing setups for airborne transmission studies:
Direct Sampling: Successful collection of direct aerosol and excretion sampling from animals during transmission experiments, providing critical data to scientists in real time.
Minimal Disturbance: Non-threatening and non-disruptive interaction with study subjects, ensuring minimal stress and accurate data collection.
Controlled sampling: The robot allows for precise control and selection of sampling locations, heights, and intervals within the animal enclosure.
Intelligent control system: that can be programmed to adjust the robot's movement speed, sampling intervals, manual remote-control, and other parameters, providing flexibility and customization based on the specific study requirements.
Integration of multiple biosensors to detect viruses and measure environmental properties during exposure events, enabling comprehensive data acquisition.
Iterative design: Improvements based on feedback from scientists, leading to enhanced performance, usability, and adaptability to diverse experimental setups.
Real-time Monitoring: The inclusion of sensors enables the robot to provide real-time data on environmental conditions, facilitating immediate analysis and adjustments.
Decontamination: the robot body is non-porous and can be decontaminated for experiment reuse.
Potential for expansion into human studies, facilitating a better understanding of virus transmission in real-world scenarios and guiding effective preventive measures.

### CONCLUSION

“A Robot for Direct Sample Capture in a Live Animal Study” presented herein provides a new and innovative solution to the challenges associated with collecting direct air samples in animal research. The robot is designed to minimize any disturbance to the animal's environment or behavior, while providing reliable data for analysis to achieve scientific study objectives. The robot can be controlled remotely by a human operator and can navigate through different environments and terrains with ease. The battery system can sustain continuous operation for extended periods, accommodating prolonged exposure experiments. It's slow and stable movement, autonomous and human-controlled maneuverability, adjustable sampling heights, and robustness ensure minimal disturbance to the animals while maintaining accuracy and reliability in data collection.

The robot for sampling air in a live animal study has numerous applications in scientific research fields, including ecology, animal behavior, toxicology, environmental studies, medicine, and biology where accurate and non-invasive aerosol sampling is essential and represents a significant advancement in scientific research.

The detailed description provided in this patent application supports the claims made regarding the robot's design, functionality, and its contribution to capturing direct samples in live animal studies. It describes the robot's compact and maneuverable body, programmable drivetrain, intelligent control system, battery system, obstacle sensors, and ability to attach biosensors for aerosol collection and environmental sensors. The iterative design process, driven by transmission data collected from animal studies, is also discussed, supporting the claims of successful interactions with study subjects, direct air sample collection, and the presence of biologics on the robot's surface.

The Applicant hereby requests that this utility patent application be examined and granted in accordance with the patent laws and regulations of the relevant jurisdiction. The Applicant is the rightful owner of the invention and seeks exclusive rights to the A Robot for Direct Sample Capture in a Live Animal Study.

These claims represent some of the potential embodiments and methods associated with the robot in live animal studies. They define the unique features, functionalities, and applications of the invention, providing a basis for patent protection and exclusivity in the respective fields. These claims provide specific details about the components, features, and methods of the invention, outlining the scope of protection sought for the “A Robot for Direct Sample Capture in a Live Animal Study”.

Legal and Technical Language: Throughout this utility patent application, clear and precise language has been used to describe the invention's components, functionalities, and its relevance to direct sample capture in live animal studies. Technical terminology specific to robotics has been appropriately utilized. The application complies with the legal requirements for patent applications, providing a detailed description of the invention's novel aspects and distinct claims.

1. An apparatus that can be placed in an enclosure with animals, interact with the animals, and can collect direct samples from the animals.

2. The apparatus of claim 1, wherein the apparatus can be a robot comprising a stable and maneuverable robotic platform.

3. The apparatus of claim 1, wherein the apparatus can be a robot equipped with wheels or tracks for leveling and adapting to different surfaces ensuring slow and smooth movement.

4. The apparatus of claim 1, wherein the apparatus can have a compact design, allowing for precise positioning and movement within laboratory settings.

5. The apparatus of claim 1, wherein the apparatus can be a robot with a sampling mechanism with multiple air intake ports strategically placed to capture air samples at different heights and positions within the animal enclosure.

6. The apparatus of claim 1, wherein the apparatus can be a robot enabled with sensors for monitoring environmental parameters such as temperature, humidity, and gas concentrations.

7. The apparatus of claim 1, wherein the apparatus can be a robot with cameras and biosensors to capture environmental measurements and establish correlations between environmental conditions and study objectives.

8. The apparatus of claim 1, wherein the apparatus can be a robot with an intelligent control system comprising sensors, actuators, and a CPU, programmed to control the movement, speed, and stability of the robot during air sampling.

9. The apparatus of claim 1, wherein the apparatus can be a robot with navigation algorithms, obstacle detection sensors, and safety protocols to avoid collisions with obstacles or animals.

10. The apparatus of claim 1, wherein the apparatus can be a robot with a power supply for providing energy to the robot during operation.

11. The apparatus of claim 1, wherein the intelligent control system is capable of autonomous operation or remote control by an operator.

12. The apparatus of claim 1, further comprising wireless communication capabilities for remote monitoring and control of the robot.

13. The apparatus of claim 1, wherein the robotic platform incorporates safety mechanisms to maintain stability and prevent harm to study subjects or objects within the enclosure.

14. The apparatus of claim 1, wherein the sensors and cameras provide real-time data on environmental parameters, enabling immediate analysis and adjustments during the live animal study.

15. A method for sampling air in a live animal study, comprising the steps of 1) Moving an apparatus comprising a sampling unit within an enclosure containing animals while collecting air samples using the sampling unit; 2) Monitoring environmental parameters using the sensors; 3) Using a combination of navigation techniques including navigation algorithms and obstacle detection sensors to avoid collisions with obstacles or the animals.

16. The method of claim 15, further comprising the step of remotely monitoring and controlling the robot using wireless communication capabilities.

17. The method of claim 15, wherein the air samples are collected at multiple heights and positions within the animal enclosure for comprehensive analysis.

18. The method of claim 15, wherein the navigation techniques also include human manual remote-control.

19. A method for collecting expelled air, secretions, and excretions from study subjects using the robotic system, substantially as described and illustrated herein.
